(19) United States
(12) Patent Application Publication
(10) Pub. No.: US 2023/0339263 A1
(43) Pub. Date: Oct. 26, 2023

(54) Hub for Bicycle Wheel, Assembly for Such a Hub, and Bicycle Wheel Comprising Such a Hub

(71) Applicant: FRANK PRÄZISIONSTEILE GMBH, Murr (DE)

(72) Inventor: Christian Jenny, Backnang (DE)

(21) Appl. No.: 18/003,075

(22) PCT Filed: Jul. 1, 2021
(86) PCT No.: PCT/DE2021/100569

§ 371 Date: Dec. 22, 2022

(30) Foreign Application Priority Data
Jul. 2, 2020 (DE) 10 2020 117 539.6

(51) Int. Cl. B60B 27/02; B60B 27/04; B60B 27/00

(52) U.S. Cl. CPC B60B 27/023; B60B 27/0031; B60B 27/047; B60Y 2200/13

(57) ABSTRACT

In an embodiment a hub for a bicycle running wheel includes a hub body and a freewheel body, wherein the hub body and the freewheel body are connected via a conical toothing arrangement.

This patent application is a national phase filing under section 371 of PCT/EP2021/100569, filed Jul. 1, 2021, which claims the priority of German Utility Model 10 2020 117 539.6, filed Jul. 2, 2020, each of which is incorporated herein by reference in its entirety.

### TECHNICAL FIELD

The present invention relates to a hub for a bicycle wheel, a hub body, a freewheel body for such a hub, an assembly for such a hub, a bicycle wheel having such a hub, and a bicycle comprising such a wheel.

The present invention further relates to a hub for a drivable running wheel of a bicycle such as a rear wheel hub.

The present invention yet further relates to a hub that may be employed in a purely muscle-driven bicycle. The hub is also suitable for bicycles which support the user pedal force with an electric carry-on motor including a rechargeable battery (so-called pedelec, e-bike).

### BACKGROUND

In prior art, hubs are known comprising a hub body that co-rotates with the running wheel. The hub is driven, for example, via the pedal cranks and a chainring of the bottom bracket via a drive means (in particular a chain), namely via a force transmission means on the hub. So-called cassettes (pinion packages) are widely in use, currently in an arrangement of up to 12 or even more. The pinion package is operated by a (rear) derailleur, which is known per se. The force transmission means is seated on a freewheel body of the hub. The freewheel body is formed separately from the hub body. A so-called freewheel operates between the hub body and the freewheel body, which freewheel engages in the presence of a pedaling movement, thus transmitting the pedaling force via the force transmission means to the hub and thus to the driven running wheel.

However, if the user does not perform any pedaling motion, the engagement of the freewheel is released so that the pedal crank without load does not necessarily co-rotate with the rear wheel hub. In the freewheel, for example, a ratchet system or a pair of axially acting spur toothings acting against each other under spring tension may be realized. In this regard, the person skilled in the art will recognize a wide variety of configurations.

From European Patent Publication EP 2 221 192 A1, a freewheel with a spur toothing is known.

Prior art hubs comprising a hub body and a separate receiving area for a force transmission means, in particular with a freewheel operating therebetween, on the one hand, require a bearing arrangement of the hub body in relation to the wheel axle, for which purpose two opposing rolling bearings are generally provided. On the other hand, the receptacle for the force transmission means (namely the freewheel body), is to be mounted separately and thus generally requires two additional roller bearings.

However, the known state of the art, providing a spur toothing between these components, also has drawbacks.

The freewheel is subject to wear due to the permanent sliding of toothing elements against each other. Internal friction always exists, at the expense of kinetic energy. Furthermore, such a hub requires regular maintenance. The maintenance intervals are usually short. When a new freewheel is put into operation, the toothing partners exhibit a running-in behavior, i.e. a stationary operating state will not be reached before reaching a specific amount of coordinated wear of the toothing partners.

The known spur toothing has only a limited tooth surface area in order to be able to transmit the high drive torques. Increasing the surface area by forming the spur toothing in a flange projecting radially from the freewheel body, has the effect of increasing the total space required for the freewheel and hub body assembly.

### SUMMARY

Embodiments overcome the disadvantages known from prior art.

Further embodiments provide a hub for a bicycle wheel which, having a compact design, enables high torque transmission with low wear, has a minimum mass, is low in maintenance or maintenance-free, and has improved running performance. In this context, a suitable assembly for such a hub, a running wheel comprising such a hub, and a bicycle comprising such a running wheel will also be provided.

Advantageous embodiments and further developments of the invention are the subject-matter of the dependent claims.

According to embodiments a hub according to the invention for a bicycle wheel comprises a hub body as well as a freewheel body, wherein a conical toothing is produced between the hub body and the freewheel body.

According to embodiments a respective hub body and the respective freewheel body are disclosed.

According to embodiments an assembly for a hub comprises a respective freewheel body and a respective hub body, optionally including a toothed washer.

According to embodiments a hub preferably comprises at least one such assembly, a wheel axle, two rolling bearings for supporting the freewheel body on the axle, and two rolling bearings for supporting the hub body on the axle.

According to embodiments a running wheel is described. The running wheel preferably comprises at least one hub, as well as a rim and spokes.

According to embodiments a bicycle is described. The bicycle comprises at least one running wheel.

Embodiments of the invention provides at least one of the following advantages:

The conical toothing allows for a more compact and lightweight design compared to the spur toothing. The conical shape of the toothing increases the engagement area without the need for a radial flange, resulting in higher torque transmission while simultaneously realizing a smaller overall size.

Wear may thus be reduced and maintenance intervals may be extended.

The conical toothing exhibits better self-centering properties than the spur toothing.

The known state of the art requires running-in. This is not necessary with the present type of toothing because of the possible centric line contact between the front and back of the tooth.

With the solution as set forth, it will become easier to incorporate one or more vent holes in the hub.

Different materials and coatings may also be realized.

The determination base for the cone angle is considered to be the angle of the cone that is introduced into the workpiece before the toothing is formed or cut/milled or produced in some other way. Accordingly, the ½ cone angle, namely the cone inclination, is defined as the angle between a ruler, bar or a similar object applied to the top of the tooth, and the longitudinal axis of the workpiece, namely at their point of intersection.

In the following, embodiments according to the invention will further be discussed, for which purpose reference will partially be made to the non-limiting advantageous embodiments and further developments of the invention. The features of advantageous further developments may be realized individually or may also be realized in any combination, thus creating further advantageous embodiments of the invention.

Preferably, in the end of the freewheel body facing the hub body, an end-side toothing is introduced which circumscribes an opening cone angle. In other words, the end-side toothing of the freewheel body is configured such that - as viewed from the center axis - it is outwardly directed both in the longitudinal direction and in the radial direction. The surface of the toothing is inclined with respect to the center axis by half the amount of the cone angle, namely the cone inclination.

Alternatively, the end of the freewheel body facing the hub body may have an end-side toothing that circumscribes a closing cone angle.

Preferably, one of the cone toothing partners, in particular the freewheel body, has a flat cone toothing with a flat opening angle.

The opening angle of the flat cone is preferably 120.1-179.9°, more preferably 121-179°, more preferably 125-175°, more preferably 130-170°, more preferably 135-165°, more preferably 140-160°, more preferably 145-155°, more preferably 150°.

Preferably, the cone is designed as a circle cone having a flat opening angle, wherein the lateral surfaces may be of concave/convex shape.

In an alternative embodiment, the cone may be designed as a steep cone, preferably having a cone angle of 30-59°. This results in greater axial than radial extension of the toothing, which reduces the overall installation space required in the radial direction.

The hub body preferably has a toothing that corresponds to the toothing of the freewheel body. If the end of the freewheel on the hub body side is designed with an opening cone angle, the corresponding end of the hub body is to be designed with a closing cone angle of the same amount, and vice versa.

The toothing of the hub body is preferably realized in a toothed washer associated with the hub body.

The end-side toothing of the freewheel body preferably interacts with a toothed washer which, on the one hand, has the corresponding conical toothing and, on the other hand, is able to suitably pass-on or introduce the torque to be transmitted into the hub body. For this purpose, the toothed washer may be comprised of an additional radial external toothing which engages with corresponding recesses in the hub body, the toothed washer preferably being displaceable in the axial direction of the hub body. Furthermore, preferably at least one resilient element is provided which presses the toothed washer against the end-side toothing of the freewheel body. In this way, engagement between the freewheel body and the toothed washer will be established when exerting a drive torque, whereas the otherwise stationary freewheel and the hub body, which co-rotates with a forward movement of the wheel, can slide against each other with their toothing, thus achieving the purpose of the freewheel. The principle of such a toothed washer and the interaction thereof with the hub body are known per se.

In the present context, an optional toothed washer is understood to be as well part of the hub body.

Preferably, within an optional toothed washer of the hub body, the ratio of the number of teeth of the conical toothing to the external toothing is 1:1 or alternatively 1:2, or generally 1:N, where N is an integer. This means that the respective force flow between a tooth of the conical toothing and a tooth of the external toothing remains essentially in the teeth and does not impact, or only slightly impacts, the sensitive region between the tooth and the tooth root.

On the side facing away from the hub body, the freewheel body preferably has a receiving area for a force transmission means. The force transmission means can in particular comprise a cassette (pinion package) or a washer or sprocket. A force transmission means can be driven by a drive means known per se. The drive means may in particular comprise a chain or a belt.

Preferably, the cone toothing pair is only in two parts, in particular consisting of a freewheel body and a hub body, or of a freewheel body and a toothed washer.

Preferably, venting of the three chambers located within the hub (hub body or hub body space, toothing space, freewheel or freewheel space; in the case of a front wheel hub, only the hub body) may be performed via bores and/or slots and/or openings and/or specially shaped end caps. End caps at the ends of the axle allow air to flow in and out of the interior of the wheel axle. The advantage of this is that when the hub cools down (e.g. during a downhill run, at nightfall, upon changing between sun and shade, or when the hub, which has been warmed up in the sun, is sprayed with water), negative pressure in those chambers, as a result of which air with water and possibly also pollutant may be aspirated into the interior through the seals, such as the seals of the rolling bearings, or through the seal of the freewheel, to cause damage therein, no longer exists.

It is particularly preferred to vent the freewheel chamber and/or then dedicated axle end caps so as to allow pressure equalization. If conventional axle end caps are completely bearing-on, they will prevent or reduce such pressure equalization. However, pressure equalization may be achieved by introducing any suitable shapes that allow air to circulate and/or allow pressure equalization, in particular milled recesses, slots or passages in the hub body and/or the axle and/or the end caps, as shown, for example, in FIG. 5. Pressure equalization may also be achieved by introducing knurlings at the contact points of the end caps or the axles to the frame.

It should be particularly pointed out that optional venting and advantageous designs thereof may be realized as advantageous embodiments of the above-described conical toothing.

Particularly preferably, a specific tooth form is provided within the conical toothing, always ensuring line contact, and depending on the design, possibly also surface contact and full-surface contact, between the toothing partners. This allows higher forces to be transmitted with less wear. In addition, the teeth can roll against each other, so that less friction occurs. Likewise, due to the surface and line contacts less wear occurs during sliding.

In prior art, during the freewheel mode (idle mode), point contact between the tooth partners on the back side of the spur toothing teeth generally occurs.

With the tooth form as herein provided, no point contact occurs. Due to a specifically manufactured surface on the backside of the tooth, to which a straight line intersecting the longitudinal axis of the hub can always be applied, at least one line contact always exists, possibly also surface contact or partial surface contact exists, between two corresponding toothing partners, thus resulting in much less wear.

Production of this specific tooth form may be done by milling, or may require specific shaping and broaching tools.

Preferred examples of the above-mentioned tooth form will be described in more detail while reference will be made to FIGS. 6-11.

It should be particularly pointed out that the suggested improved tooth shape can be realized as an advantageous embodiment of the previously described conical toothing.

The freewheel of the hub, on its side facing away from the hub body, preferably comprises a receiving area and/or an external thread for receiving and/or fixing a force transmission means.

The receiving area for the force transmission means can have an external thread on its circumference for fixing the force transmission means (in particular a cassette). The cassette preferably has an inner sleeve extending to the outside of the smallest pinion, which is screwed onto the thread of the receiving area from the smallest pinion using a suitable nut, wherein the matching inner profile of the cassette travels across the receiving profile of the receiving area of the cassette, thus producing a form fit between the cassette and the receiving area in the circumferential direction so as to transmit force. Such fixations for cassettes are known per se.

The receiving area for the force transmission means can alternatively have a receiving profile substantially extending to the outer end of the receiving area, onto which receiving profile a force transmission means a cassette) may slidingly be placed. Subsequently, the cassette may be fixed with an end nut which engages in an internal thread of the essentially cylindrical receiving area. A driving force may then be transmitted in the circumferential direction via the receiving area profile and the corresponding inner profile of the cassette. Such fixations for cassettes are known per se.

### BRIEF DESCRIPTION OF THE DRAWINGS

Supplementary or additional to the advantageous embodiments and further developments of the teachings already discussed, examples embodiments of devices according to the invention shown in the drawing in the scope of FIGS. 1 to 11 are explained in more detail. However, the examples discussed by making reference to the drawing do not limit the invention to the examples shown. In discussing the examples embodiments by making reference to the drawing, preferred embodiments and further developments of the technical teachings will also be shown in general.

Further developments of the above-described advantageous embodiments having the features of the following examples embodiments expressly constitute further advantageous embodiments of the invention, just as further developments of the below-described examples embodiments having the features of the above-described embodiments expressly constitute further advantageous embodiments of the invention, thus form part of the present disclosure.

With respect to the following illustration of the figures, it should be pointed out in general that reference numbers already shown in previous figures and already explained in this respect above, have not fully been adopted in the subsequent figures for reasons of clarity and/or are not explained again in some cases based on the subsequent figures. For illustrating such reference numbers and the associated technical features, reference is made to the respective description of the respective preceding figures in its entirety to avoid repetition, wherein:

FIG. 1 is a preferred example embodiment of the hub according to the invention in a lateral sectional view;

FIG. 2 is the freewheel body of the hub of FIG. 1 in a lateral view, in a lateral sectional view, as well as in a perspective lateral view;

FIG. 3 is the toothed washer of the hub body of the hub of FIG. 1 in a lateral view, a plan view, in a lateral sectional view, as well as in a perspective view, respectively;

FIG. 4 is a side view of the freewheel body of FIG. 2 (bottom) and the toothed washer of FIG. 3 (top), the two portions being suitably engaged with each other;

FIG. 5 is another preferred example embodiment of a hub according to the invention, herein including an optional venting system, in a partially cut lateral view;

FIG. 6 is a lateral perspective view of the freewheel body of FIG. 2, with auxiliary lines to illustrate a specific form of conical toothing;

FIG. 7 is an enlarged section taken from the illustration in FIG. 6;

FIG. 8 is another enlarged section taken from the illustration in FIG. 7; used to explain the specific shape of the conical toothing;

FIG. 9 is a lateral perspective view of the toothed washer of FIG. 3; which has a specific shape of the conical toothing corresponding to the freewheel body of FIGS. 6 to 8, which is illustrated by auxiliary lines drawn and in correspondence to FIG. 6;

FIG. 10 is an enlarged section taken from the illustration in FIG. 9; and

FIG. 11 is another enlarged section taken from the illustration in FIG. 10.

### DETAILED DESCRIPTION OF ILLUSTRATIVE EMBODIMENTS

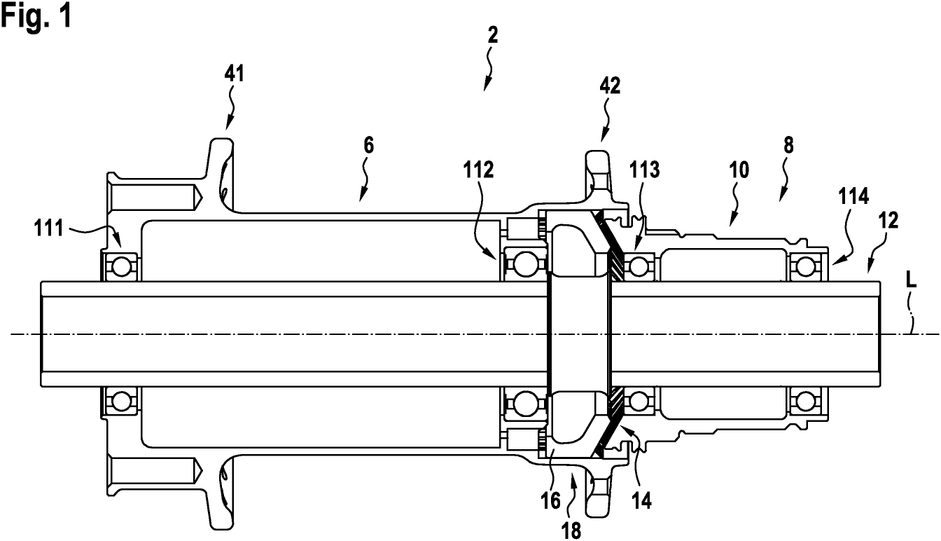

FIG. 1 shows a preferred example embodiment of the hub 2 according to the invention for a bicycle wheel in a lateral sectional view. The example shown is a rear wheel hub. The hub 2 is viewed from behind in the direction of travel of the bicycle.

The hub 2 comprises a left and a right spoke flange 41, 42. The region at the left side of the right spoke flange 42 is the hub body 6. The region at the right side thereof is the freewheel body 8. The freewheel body 8 comprises a receiving area 10 on the outside for a force transmission means, which herein is a pinion package (cassette, not shown).

The Hub body 6 and the freewheel body 8 represent the assembly for a hub 2 according to the invention.

Both the hub body 6 and the freewheel body 8 are each rotatably mounted on the axle 12 (wheel axle 12) using two rolling bearings 111, 112, 113, 114.

The hub for a bicycle wheel according to the invention comprises a hub body 6 and a freewheel body 8, wherein a conical toothing 14 is produced between the hub body 6 and the freewheel body 8.

The freewheel produced with the freewheel body 8 is for decoupling the hub body 6 in a known manner, which hub body 6 always rotates with the forward movement of the bicycle, from the drive when no drive torque is applied. As soon as a drive torque is applied, the freewheel is required to immediately re-establish engagement between freewheel body 8 and hub body 6.

Herein, the end-side toothing 14 of the freewheel body 8 interacts with a toothed washer 16 of the hub body 6, which, on the one hand, has the corresponding conical toothing 14 and, on the other hand, can suitably pass on or introduce the torque to be transmitted into the hub body 6. For this purpose, the toothed washer 16 has another radial external toothing 18, which engages with corresponding recesses in the hub body 6, wherein the toothed washer 16 is displaceable in the axial direction of the hub body 6.

Furthermore, a resilient element is provided which presses the toothed washer 16 against the end-side toothing 14 of the freewheel body 8. Thus, when a driving torque is applied, engagement between freewheel body 8 and toothed washer 16 is established, while the stationary freewheel body 8 and the hub body 6, which co-rotates with a forward movement of the running wheel, can otherwise slide against each other with their toothing 14, thus achieving the purpose of the freewheel.

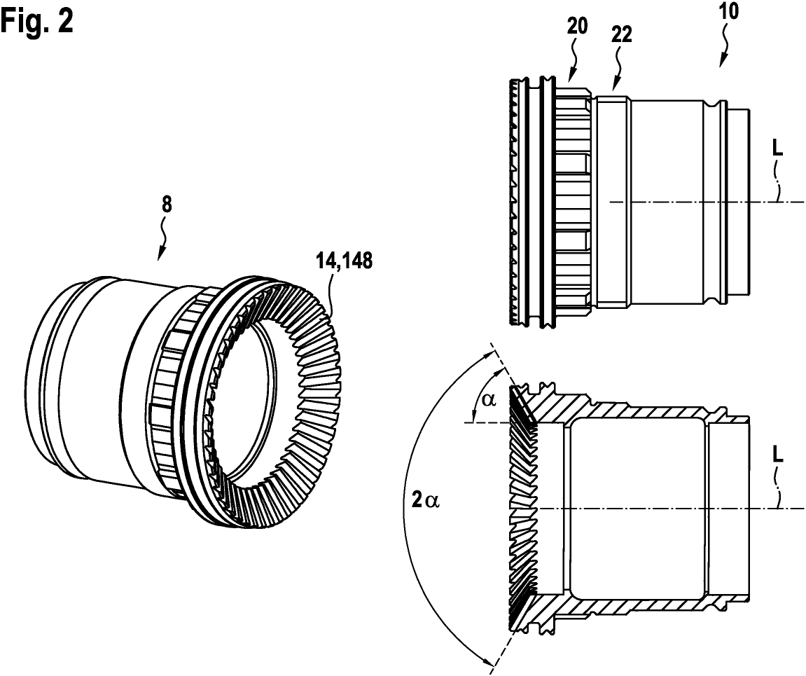

FIG. 2 shows the freewheel body 8 of the hub 2 of FIG. 1 in a lateral view, in a lateral sectional view, and in a perspective lateral view, respectively. Herein, an end-side toothing 14, 148 is introduced in the end of the freewheel body 8 facing the hub body 6, which toothing circumscribes an opening cone angle 2α. The surface of the toothing 148 is thereby inclined by half the amount α of the cone angle 2α with respect to the center axis (longitudinal axis) L. This angle (cone inclination) α is 61° in this example, so that herein the cone angle 2α is 122°.

In addition to the conical toothing 14, 148, the freewheel body 8 has a receiving profile 20 for torque transmission from the force transmission means (not shown here) and next to it an external thread 22 for fixing the force transmission means.

The force transmission means, which herein is a cassette (not shown herein), has an inner sleeve extending to the outside of the smallest pinion, which is screwed onto the external thread 22 of the freewheel body 8 from the smallest pinion direction using a suitable nut, wherein the matching inner profile of the cassette travels across the receiving profile 20 of the freewheel body 8, thus creating a form fit between the cassette and the freewheel body 8 in the circumferential direction so as to transmit force. Such a system for fixing a cassette and for transmitting torque from a cassette to a hub 2 is known from the company SRAM® under the designation XD®.

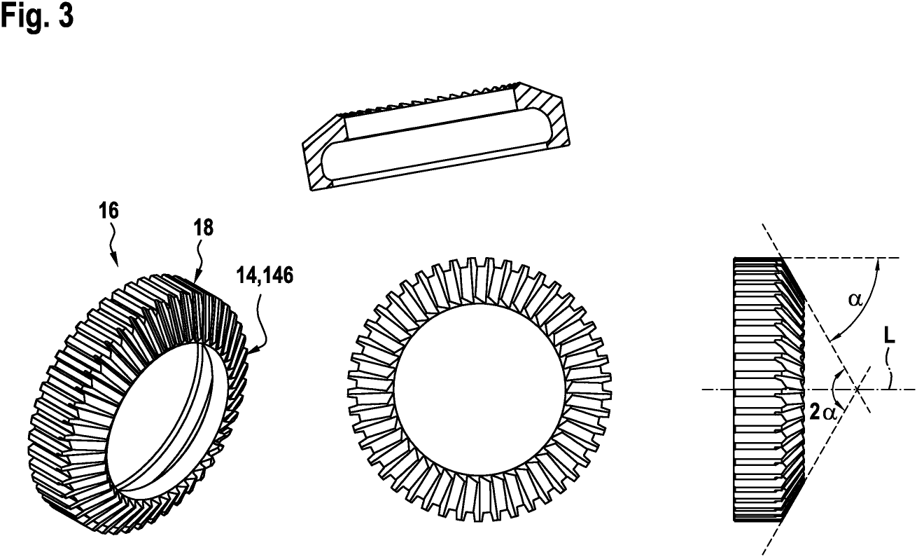

FIG. 3 shows the toothed washer 16 of the hub body 6 of FIG. 1 in a lateral view, a top view, a lateral sectional view and a perspective view.

In the direction of the center axis L, the toothed washer 16 initially has a conical toothing 14, 146 corresponding to the conical toothing 148 of the freewheel body 8. Since the end of the freewheel body 8 on the hub body side herein is designed with an opening cone angle 2α (cf. FIG. 2), the toothed washer 16 is designed with a closing cone angle 2α of the same amount, namely 122°. The amount of the cone inclination α of the cone toothing 146 relative to the center axis L is 61° for the toothed washer 16 as for the freewheel body 8 in this example embodiment.

Furthermore, the further radial external toothing 18 of the toothed washer 16 for engagement with the hub body 6 is clearly visible here. In this case, the toothed washer 16 remains displaceable within the hub body 6 in the direction of the longitudinal axis L.

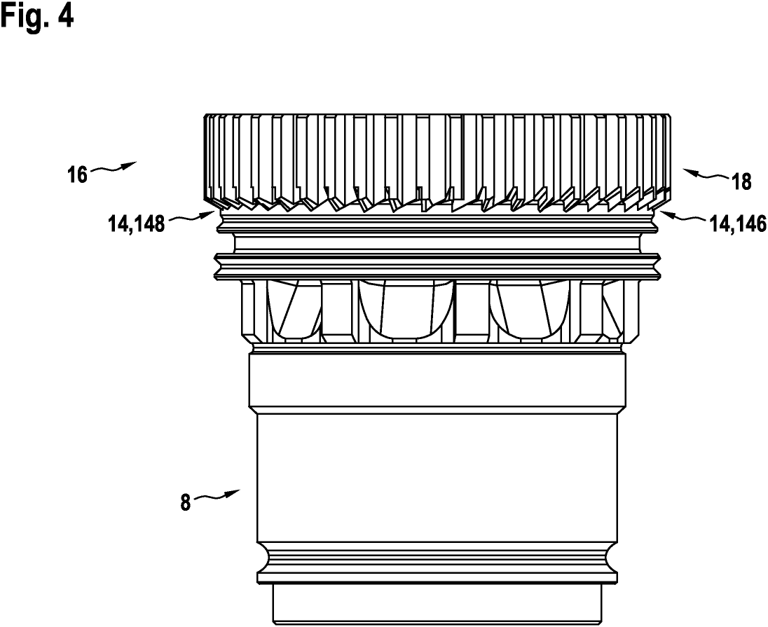

FIG. 4 shows a side view of the freewheel body 8 of FIG. 2 (bottom) and the toothed washer 16 of FIG. 3 (top), these two parts 8, 16 being in engagement with each other in a predetermined manner. The toothed washer 16 has been inserted with its conical toothing 14, 146 into the conical toothing 14, 148 of the freewheel body 8. Thus, herein the conical toothing 14 in question is formed as a whole between the hub body 6 (via the toothed washer 16) and the freewheel body 8.

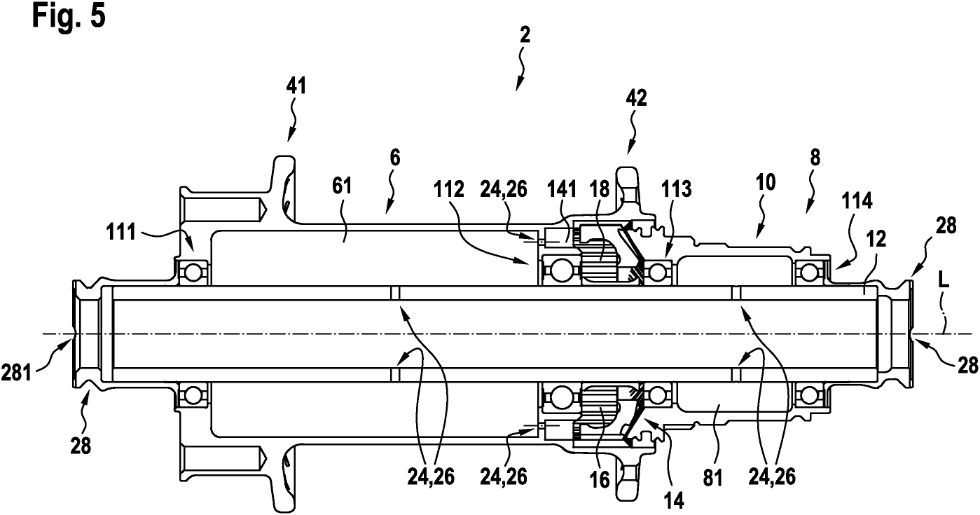

FIG. 5 shows another preferred example embodiment of a hub 2 according to the invention in a partially sectioned lateral view.

This example embodiment initially corresponds to that of FIG. 1, but with an optional venting system implemented herein.

Herein, venting of the three chambers inside the hub 2 (hub body chamber 61, toothing chamber 141 and freewheel chamber 81) is achieved. For this purpose, vent openings 24, herein provided as venting holes 26, are arranged between free-wheel chamber 81 and axle 12, toothing chamber 141 and hub body chamber 61, and hub body chamber 61 and axle 12, respectively.

Other variable contours may advantageously be provided to enable circulation / pressure equalization. Depressions, recessed surfaces, surface slots, or straight or spirally wound depressions or channels can be made, in particular milled, in the outer surface (jacket) of the axle 12. Air can flow through such recesses below the inner ring of a rolling bearing 111, 112, 113, 114 seated on the shaft 12, i.e. between the shaft 12 and the inner ring.

Dedicated end caps 28 located at the ends of the axle 12 also allow air to flow into or out of the interior of the axle 12. The end caps 28 have variable contours, in particular bores or slots 281, which open when an overpressure or underpressure is applied, thus enabling pressure compensation. For this purpose, the end caps 28 can be made of flexible material, for example plastic material. Thus, the inner space of the wheel axle 12 is also vented.

Thus, in the above-mentioned chambers 61, 81, 141 pressure equalization with the environment can always be maintained via the vent openings 24, 281.

The benefit therefrom resides in that when the hub 2 cools down, negative pressure no longer exists in the chambers 61, 81, 141, aspirating air with water and possibly also pollutants into the interior of the hub 2 through gaps or seals, such as those of the rolling bearings 111, 112, 113, 114, or the freewheel body 8, to cause damage therein.

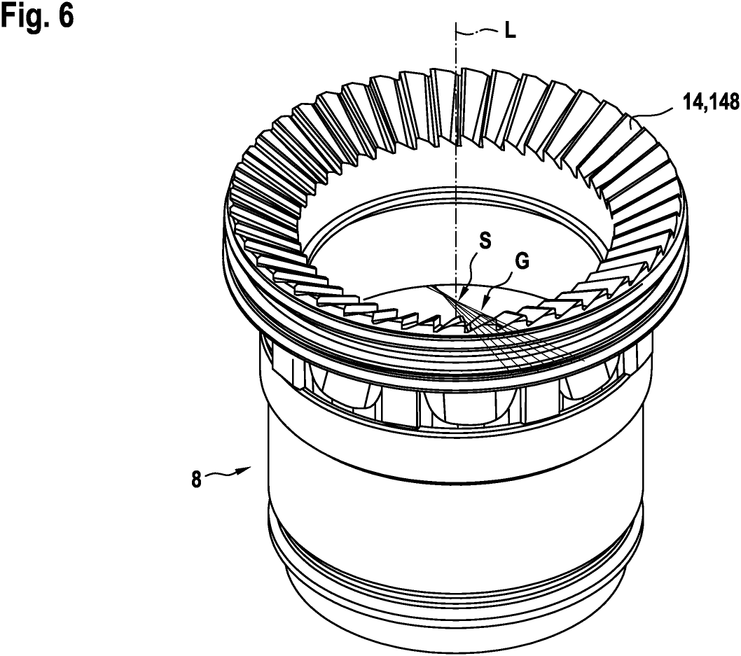

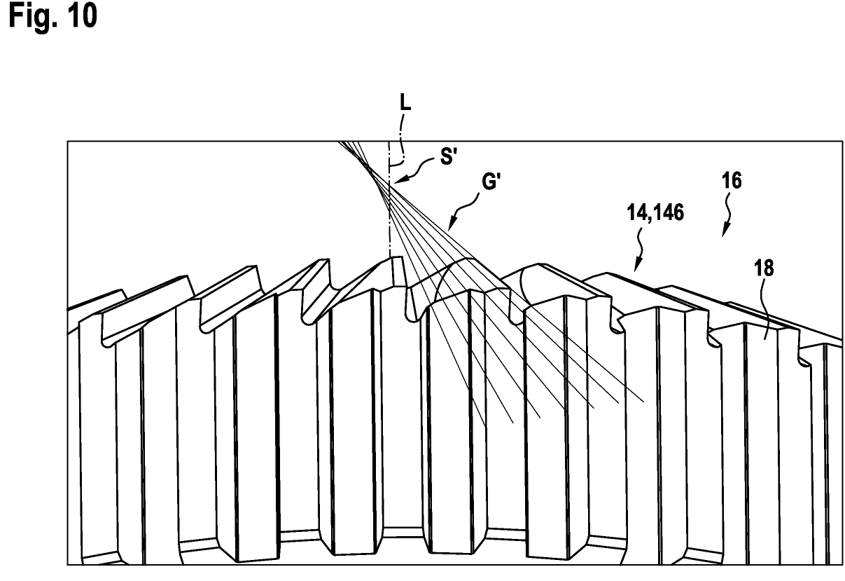

FIGS. 6 to 11 illustrate an optional and specific tooth form for the above-mentioned conical toothing 14, in which line contact and, depending on the design, surface and full-surface contact are always produced between the toothing partners 148, 146. This allows higher forces to be transmitted with less wear. In addition, the opposing teeth 30 slide against each other, so that less friction is likely to occur. Likewise, there will be less risk of wear during sliding due to the arising surface and/or line contact.

Thus, with smaller overall size, greater force transmission is possible.

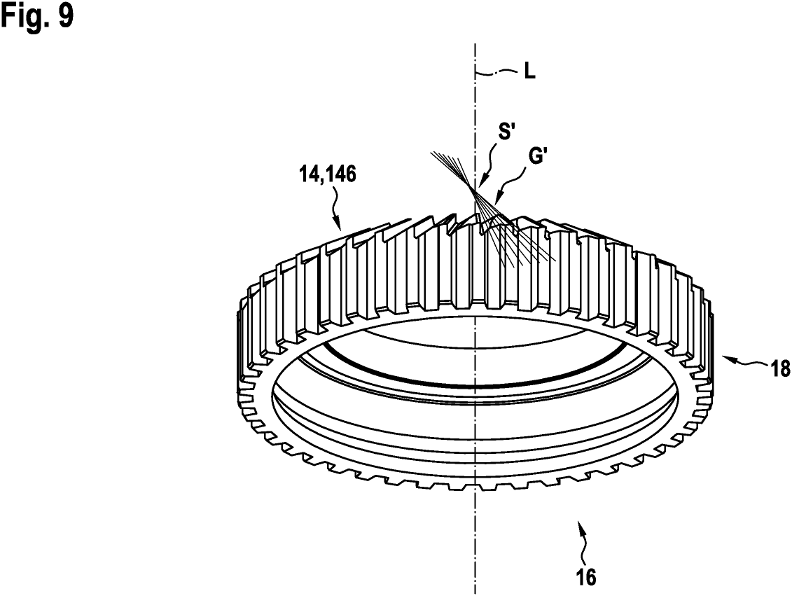

FIGS. 6 to 8 show the specific tooth form on the conical toothing 14, 148 of the freewheel body 8 from FIG. 2, while FIGS. 9 to 11 illustrate the specific tooth form on the corresponding conical toothing 14, 146 of the toothed washer 16 from FIG. 3 of a hub body 6 from FIG. 1.

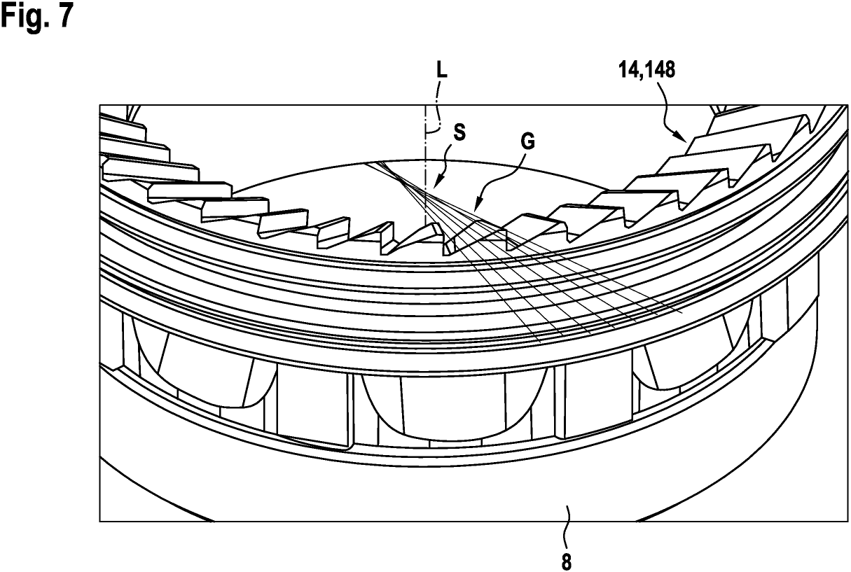

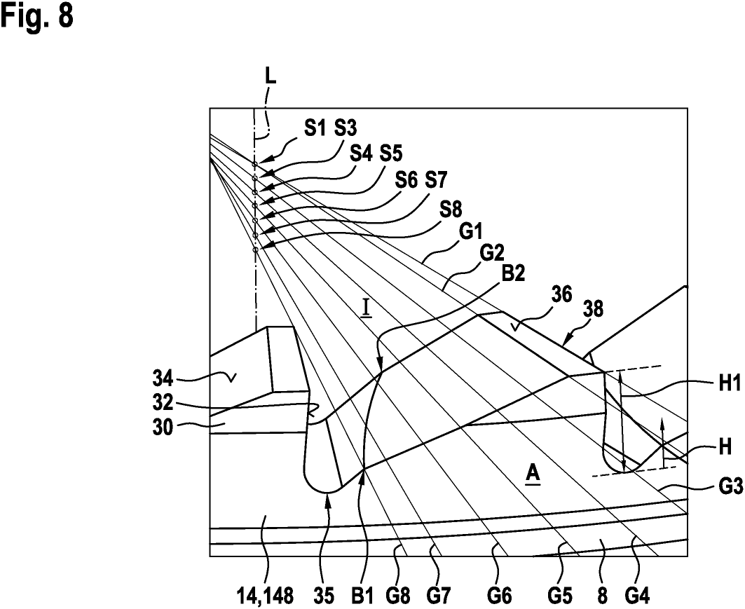

The illustration of FIG. 8 shows a detailed representation of a tooth 30 of the conical toothing 148 of the freewheel body 8 entirely shown in FIG. 6, which in turn is shown in detail and enlarged in FIG. 7. The auxiliary lines or straight lines G and the intersections S thereof with the longitudinal or central axis L, which will be explained in the following, may be seen in all three illustrations.

The illustration in FIG. 8 shows the perspective view from the outside of an essentially cylindrical freewheel body 8 with a conical toothing 14, 148 at the upper end.

Each tooth 30 of the conical toothing 148 has a counterclockwise tooth front side 32 and an upwardly and rearwardly delimited tooth backside 34.

Inside the device, the longitudinal axis L of the freewheel body 8 is shown.

Herein, the height H of the tooth, measured from the tooth base 35, is H1.

The tooth 30 has a shoulder 36 of the same height H1 on the upper side. The shoulder 36 is shaped such that a straight line G1 applied to the leading edge 38 of the tooth and a straight line G2 applied to the rear end of the shoulder A intersect the longitudinal axis L at exactly the same point S1.

The tooth backside 34 has a specifically shaped region between the shoulder 36 and the line between B1 and B2. Starting from an intersection point S3 located below S1, a straight line G3 always exists which, starting from S3, extends between the inner side I and the outside A of the tooth exactly along the surface of the tooth backside 34.

In alternative embodiments, the tooth backside 34 may also be convex, concave, elevatedly curved into a circular section consisting of several curves, or may be formed as an ellipse or be planar and multi-surfaced.

Also, in alternative embodiments, the surface of the shoulder 36 may be formed as a circular section (rounded) or as a surface that is slightly inclined to the front of the tooth 32, preferably with an inclination of 0-20°. The highest point of the tooth 30 is then no longer located on the line G1, but travels from the tooth front 32 in the direction of the line G2.

The surface of the shoulder 36 can then rise from line G1 in the direction of line G2, or is straight-planar as described herein.

Returning to the specific example embodiment shown in FIGS. 6 to 8, there is also a straight line G4 to G7 to each of the intersection points S4 to S7, which, starting from the respective intersection point between the inner side I and the outer side A of the tooth 30, exactly extends along the surface of the backside 34 of the tooth.

The lowest intersection point S8, for which this condition applies, is the intersection point for the straight line G8, which contacts the tooth 30 exactly at point B1 of the region boundary, and there, it is located as a tangent to the surface of the region between the shoulder 36 formed on the leading edge 38 and the line between B1 and B2 on the backside 34 of the tooth.

Now a second body 16, which has a toothing 146 like the toothing 148 of the freewheel body 8 shown, but which must have the negative amount of the cone inclination α of the toothing 148, is turned over and is placed from the top of the freewheel body 8 shown. Then, the second body 16 is rotated counterclockwise with respect to the illustrated freewheel body 8 so that the toothings 148, 146 are not engaged, but slide against each other.

The second body 16 is preferably a toothed washer 16 which is in engagement with the previously described freewheel body 8. This is shown in FIG. 4.

A corresponding toothed washer 16 having a corresponding conical toothing 146 and corresponding to the freewheel body of the previous figures, as well as already shown in FIG. 3, is shown in FIGS. 9 to 11. To illustrate the toothing 146 realized therein, reference can be made to the above and following explanations of FIGS. 6 to 9 by way of the freewheel body 8.

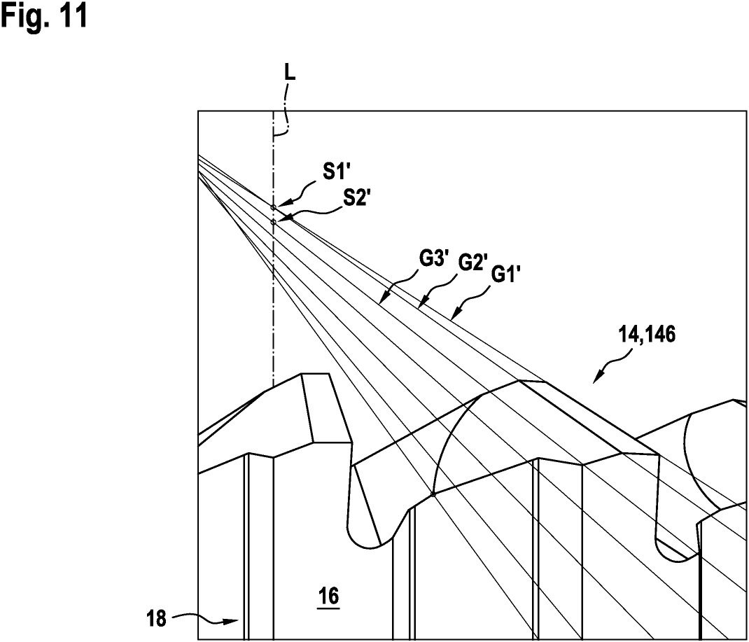

Returning now to the illustration of FIG. 8, there is thus - due to the identical or corresponding tooth forms - a straight line G between G2 and G8 for each position of the then opposing toothings 148, 146, which exactly represents the actual line of contact between the two opposing toothings 148, 146. Or in other words: at each moment of sliding of the tooth backsides 34, the straight line G of the toothing 148 of the freewheel body 8 exactly coincides with the corresponding straight line G′ (not shown in FIG. 8, see FIG. 11) of the corresponding toothing 146 of the toothed washer 16 in the contact region of the two toothings 148, 146, thus this straight line G=G′ necessarily forms the actual contact line between the toothings 148, 146.

Therefore, at least one line contact between the toothings 148, 146, in this case of the freewheel body 8 and the toothed washer 16, in the region between the straight line G2 and the line B1-B2, is always to be present.

The same applies when the toothings 148, 146 slide along the straight line G2 in the direction of the shoulder 36 and along the straight line G1 from the shoulder 36 in the direction of the tooth base 35. At this moment, the straight lines G2 and G2′ or G1 and G1′ of the opposing toothings 148, 146 meet each other so that line contact is ensured.

Preferably, instead of a line contact, it may as well be a surface or partial surface contact, if instead of the straight lines G2 to G8, surfaces or partial surfaces are realized, which are arranged in alignment with the longitudinal axis L.

In general, a design of the tooth front side 32 and/or the tooth backside 34 is preferred, wherein the geometry thereof, regardless of whether it is concave, convex, planar or partial-surface, is always aligned with the center axis L of the component 8, 16, and/or in each position of the rolling or sliding process of the toothing partners 148, 146, the resulting contact line G, G′ or contact surface extends through the center axis L, irrespective of the amount of a cone angle 2α of the toothing 148, 146. Provided that the toothing 148, 146 has a cone angle 2α, the intersection point S, S′ of the contact line G, G′ with the center axis L of the component 8, 16 will then be accordingly higher or lower than without a cone angle 2α, but this does not necessarily affect the quality of the rolling process described herein.

In the example from FIG. 8, surface contact exists at least when the shoulders 36 of the toothings 148, 146 slide on each other.

The region of the tooth backside 34, which in FIG. 8 is located below the line B1-B2, herein is not designed as the specifically shaped region described above, since the space required for the tool for the shaping and/or broaching operation is no longer sufficient due to the adjacent tooth 30 on the left. This region can be referred to as a runout.

However, the presence and size of such a runout may vary, namely depending on the method of producing the toothing 148, 146 - for example, machining, shaping, broaching or milling.

The tooth runout can be significantly reduced in size or even completely eliminated in the case of manufacturing using 3D printing, sintering, stamping, embossing or lasering, so that, if required, the entire backside 34 of the tooth can be designed with the specific surface described above.

Although the invention has been illustrated and described in detail by means of the preferred embodiment examples, the present invention is not restricted by the disclosed examples and other variations may be derived by the skilled person without exceeding the scope of protection of the invention.

### Embodiments

In addition to the advantageous embodiments, further embodiments and examples embodiments already discussed, the invention will be described below while making reference to other preferred specific embodiments which, however, do not limit the invention to the embodiments described. These embodiments are expressly part of the present description.

Further embodiments of the above-described advantageous embodiments and examples embodiments having the features of the following embodiments expressly form further advantageous embodiments of the invention, just as further embodiments of the below-described embodiments having the features of the above-described embodiments and examples embodiments, and are thus within the scope of the present disclosure.

Embodiment 1: A hub for a bicycle running wheel, comprising a hub body and a freewheel body, wherein a conical toothing is produced between the hub body and the freewheel body.

Embodiment 2: The hub according to the preceding embodiment, wherein an end-side toothing is incorporated into the end of the freewheel body facing the hub body, which toothing circumscribes an opening or a closing cone angle.

Embodiment 3: The hub according to the preceding embodiment, wherein the cone angle is 120.1-179.9°, preferably 121-179°, more preferably 125-175°, more preferably 130-170°, more preferably 135-165°, more preferably 140-160°, more preferably 145-155°, and more preferably 150°.

Embodiment 4: The hub according to one or more of the preceding embodiments, wherein the hub body has a toothing corresponding to the toothing of the freewheel body.

Embodiment 5: The hub according to the preceding embodiment, wherein the conical toothing of the hub body corresponding to the toothing of the freewheel body is formed in a toothed washer of the hub body.

Embodiment 6: The hub according to the preceding embodiment, wherein the toothed washer is displaceable in the axial direction within the hub body.

Embodiment 7: A hub for a bicycle running wheel, comprising a hub body as well as a freewheel body, optionally according to one or more of the preceding embodiments, wherein venting of at least one of the chambers located within the hub, in particular of hub body, toothing chamber or freewheel, and/or of the interior of the wheel axle is provided.

Embodiment 8: A hub for a bicycle running wheel, comprising a hub body as well as a freewheel body, optionally according to one or more of the preceding embodiments, wherein a tooth form is provided within a toothing between hub body and freewheel body, which always establishes a line contact and/or a surface contact or full surface contact between the toothing partners.

Embodiment 9: The hub according to one or more of the preceding embodiments, wherein the freewheel, on its side facing away from the hub body, comprises a receiving area and/or an external thread for receiving and/or fixing a force transmission means.

Embodiment 10: The hub according to the preceding embodiment, wherein the force transmission means is a cassette (pinion package) or a belt pulley.

Embodiment 11: The hub according to one or more of the preceding embodiments, wherein the hub further comprises at least one of the features as set forth in the description above.

Embodiment 12: The hub according to one or more of the preceding embodiments, wherein the hub has the additional features of at least one of the examples embodiments as set forth in the description above.

Embodiment 13: The hub according to one or more of the preceding embodiments, wherein the hub is formed according to one of the examples embodiments as set forth in the description above.

Embodiment 14: The hub according to one or more of the preceding embodiments, wherein the hub has the additional features of at least one other preceding embodiment.

Embodiment 15: Assembly for a hub for a bicycle wheel according to one or more of the preceding embodiments, wherein the assembly comprises a hub body and a freewheel body.

Embodiment 16: Hub body for a hub for a bicycle wheel according to one or more of the preceding embodiments 1 to 14.

Embodiment 17: Freewheel body for a hub for a bicycle wheel according to one or more of the preceding embodiments 1 to 14.

Embodiment 18: Bicycle wheel comprising a hub according to one or more of the preceding embodiments 1 to 14.

Embodiment 19: Bicycle comprising a bicycle wheel according to the preceding embodiment.

1-22. (canceled)

23. A hub for a bicycle running wheel comprising:
a hub body; and
a freewheel body,
wherein the hub body and the freewheel body are connected via a conical toothing arrangement.

24. The hub according to claim 23, wherein an end of the freewheel body facing the hub body comprises an end-side toothing, which circumscribes an opening cone angle or a closing cone angle.

25. The hub according to claim 24, wherein the opening cone angle or the closing cone angle is between 120.1° and 179.9°, inclusive.

26. The hub according to claim 23, wherein the hub body has a toothing corresponding to a toothing of the freewheel body.

27. The hub according to claim 26, wherein the toothing of the hub body is located in a toothed washer of the hub body.

28. The hub according to claim 27, wherein the toothed washer is displaceable in an axial direction within the hub body.

29. The hub according to claim 27, wherein, within the toothed washer, a ratio of a number of teeth of a conical toothing to a number of teeth of an external toothing is 1:1 or 1:2.

30. The hub according to claim 23, wherein the conical toothing arrangement consists of only two parts, namely of the freewheel body and the hub body, or of the freewheel body and a toothed washer.

31. The hub according to claim 23, further comprising a venting of at least one chamber located within the hub, wherein the at least one chamber comprises a hub body chamber, and/or a toothing chamber, and/or a free wheel chamber, and/or an interior of a wheel axle.

32. The hub according to claim 31, wherein the venting of the at least one chamber located within the hub is realized via bores and/or slots and/or openings, and/or axle end caps.

33. The hub according to claim 32, wherein the bores and/or the slots are configured to open when an overpressure or underpressure is present thereby enabling pressure compensation.

34. The hub according to claim 32, wherein an outer surface of the wheel axle comprises recesses, recessed surfaces, superficial slots, straight or spirally wound recesses, or channels, or a mixture thereof so that air is passable between an inner ring of a rolling bearing seated on the wheel axle and the outer surface of the wheel axle.

35. The hub according to claim 23, wherein the conical toothing arrangement comprises a tooth shape which always forms a line contact and/or a surface contact or full surface contact between corresponding toothing partners.

36. The hub according to claim 23,
wherein the freewheel body is substantially cylindrical, extends along a longitudinal axis and has a conical toothing at an upper end,
wherein each tooth has a tooth front side facing in a counterclockwise direction and a tooth backside which is upwardly and rearwardly delimited, and
wherein the tooth backside has a region where a straight line which, starting from a point of intersection with the longitudinal axis between an inner side and an outer side of the tooth, exactly extends along a surface of the tooth backside.

37. The hub according to claim 36, wherein the hub body comprises a toothed washer, wherein the toothed washer has a conical toothing corresponding to a conical toothing of the freewheel body, and wherein the conical toothing of the toothed washer has a negative amount of a conical inclination of the conical toothing of the freewheel body.

38. The hub according to claim 23, wherein the freewheel body, on a side facing away from the hub body, comprises a receiving area and/or an external thread for accommodating and/or fixing a force transmission means.

39. The hub according to claim 38, wherein the force transmission means is a cassette or a belt pulley or a pinion.

40. An assembly for the hub according to claim 23, wherein the assembly consists of the hub body and the freewheel body.

41. The bicycle running wheel comprising:
the hub according to claim 23.

42. A bicycle comprising:
the bicycle running wheel according to claim 41.
